(19) United States
(12) Patent Application Publication
(10) Pub. No.: US 2016/0364984 A1
(43) Pub. Date: Dec. 15, 2016

(54) INFRARED LOGICAL MATRIX-STYLE TRAFFIC VIOLATION DETECTION METHOD AND APPARATUS

(71) Applicant: NATIONAL CHUNG SHAN INSTITUTE OF SCIENCE AND TECHNOLOGY, Taoyuan City (TW)

(72) Inventors: SHIH-CHE CHIEN, HSINCHU CITY (TW); FENG-CHIA CHANG, KAOHSIUNG CITY (TW)

(21) Appl. No.: 14/736,431

(22) Filed: Jun. 11, 2015

(51) Int. Cl. G08G 1/017

(52) U.S. Cl. CPC G08G 1/0175

(57) ABSTRACT

An infrared logical matrix-style traffic violation detection method and apparatus are introduced for use at junctions of roads to detect traffic violations, such as going through a red light illegally and speeding, incur a low cost, and manifest a competitive edge. The apparatus includes a body, a sensing device, a signal determination processing device, an image capturing device, and a M×N array zone. The method includes the steps of starting a sensing device; detecting a M×N array zone; determining whether a temperature variation has occurred to the M×N array zone, and capturing a traffic violation-related image.

### FIELD OF TECHNOLOGY

The present invention relates to infrared logical matrix-style traffic violation detection methods and apparatuses, and more particularly, to a traffic violation detection method and apparatus for use in enforcing traffic laws and regulations

### BACKGROUND

Conventional traffic violation detection systems are usually equipped with hardware apparatuses which incur high costs, such as a microwave radar, a laser radar, or an induction coil. To enhance their stability, the conventional traffic violation detection systems further comprise multiple sensors for logically judging the direction in which a vehicle is moving, albeit adding to the costs incurred by the systems. On the contrary, the recently developed image detection systems are neither efficient in operating in all weathers nor efficient in identifying pedestrians and small animals.

Furthermore, there is still room for improvement in the logical judgment made by the conventional traffic violation detection systems. For example, when triggered, the sensors fail to verify whether a wrongdoer involved in a traffic violation is a pedestrian or a small animal, nor can the sensors effectively identify motorcycles (because of their relatively small sizes). The induction coils of the conventional traffic violation detection systems are likely to break down very often and thus need regular maintenance, thereby incurring costs.

In addition, the induction coils for use with the conventional traffic violation detection system are provided in the number of two, disposed deep under a road, and positioned at a pedestrian crossing or a road junction. A traffic light is positioned at the pedestrian crossing or road junction. An image capturing apparatus (such as a camera or any picture-taking device) of the conventional traffic violation detection system is triggered to take pictures of a vehicle as soon as the vehicle passes the pedestrian crossing or road junction and thus changes the magnetic field of the two induction coils while the traffic light is red. The speed at the vehicle passes the pedestrian crossing or road junction while the traffic light is red is calculated according to the time lag between the two induction coils in undergoing the change of magnetic field. The pictures thus taken of the vehicle and the vehicle speed thus calculated together provide the evidence required to charge the driver of the vehicle for committing a traffic violation.

However, the aforesaid technique requires the vehicle to press on the road surfaces right above the induction coils in order to get an accurate detection result. In addition, the induction coils are predisposed to aging and thus deterioration in precision. After being pressed over by vehicles for a long period of time, the induction coils are not only likely to sever and thus malfunction but are also likely to incur high maintenance costs. Furthermore, the induction coils fail to detect any moving vehicles while road construction is underway. In addition, it is time-consuming and laborious to install the induction coils. For all the above reasons, the induction coils are ineffective in detecting any traffic violations.

Imported radar detection picture-taking apparatuses are expensive and subjected to limits pertaining to their functions and specifications and thus unfit for advanced update or expansion. What is more, the distances among multiple vehicles and the precise position at which a vehicle crosses a lane are discernible neither by conventional induction detection techniques nor by conventional radar detection techniques. As a result, in the situation where at least two vehicles are shown in a captured imaged, the prior art is unable to identify the drivers who commit traffic violations. For this reason, the pictures taken of the vehicles involved cannot provide any reference for use in persecuting the traffic violation wrongdoers.

Accordingly, it is imperative to overcome the aforesaid drawbacks of the prior art.

### SUMMARY

In view of the aforesaid drawbacks of the prior art, it is an objective of the present invention to provide an infrared logical matrix-style traffic violation detection method and apparatus which not only involve using an infrared temperature sensor which incurs a low cost but displays high detection efficiency to function as a primary sensing element but also involve using a microprocessor which incurs a low cost to perform sensor-based data analysis and logical computation to therefore achieve automated traffic violation detection. Hence, the present invention not only solves the problems facing conventional traffic violation detection sensors but also incurs a low cost and manifests a competitive edge.

The infrared logical matrix-style traffic violation detection method and apparatus of the present invention entails detecting a vehicle moving on a road according to the difference in temperature between the vehicle and the road (especially because the water tank of the engine of the vehicle has a relatively high temperature), using an infrared temperature sensor to detect a temperature variation in a sensing region, and dividing the sensing region into N regions of interest (ROI), so as to perform logical judgment among the blocks and thereby determine whether the vehicle has committed a traffic violation, and in consequence the infrared logical matrix-style traffic violation detection method and apparatus display high stability. The infrared logical matrix-style traffic violation detection method and apparatus are further characterized in that: even if a small animal or a pedestrian passes through the sensing region, it will be detected accurately not only by adjusting the sensor's sensitivity but also by the screening effect of the aforesaid logical judgment.

The aforesaid ROI-based logical judgment is designed in accordance with a predetermined advancing direction or path of vehicles such that only those objects which conform with the aforesaid advancing direction or path are able to trigger a traffic violation detection system alert. The infrared logical matrix-style traffic violation detection method and apparatus further require an infrared thermal imaging apparatus whereby a specific infrared signal emitted from an object is detected by optoelectronic technology so as to detect the object, convert the signal into an image pattern for use in human beings' visual recognition, and thus calculate the temperature accurately.

The present invention is characterized in that: it circumvents any visual obstacle but senses the distribution of temperature at the surfaces of an object; if the object surface temperature exceeds the absolute zero, the object generates electromagnetic wave; and, in this regard, the strength and the wavelength of the electromagnetic wave thus generated from the object vary with the surface temperature of the object. Conventional infrared sensors fall generally into two categories in accordance with the related detection principles, namely a thermal induction sensor and a photon sensor. The thermal induction sensor converts any absorbed infrared into thermal energy such that the sensor brings about a change in temperature to thereby change the physical properties of related materials, thereby detecting that a material change and thus detecting infrared. On the contrary, the photon sensor absorbs the energy derived from infrared photons such that electrons within the energy levels of the chip generates a leap to thereby effectuate the absorption of infrared and generate a voltage or current signal for the sake of measurement. Accordingly, the present invention is characterized in that a heat induction sensor functions as the primary sensing element.

### BRIEF DESCRIPTION

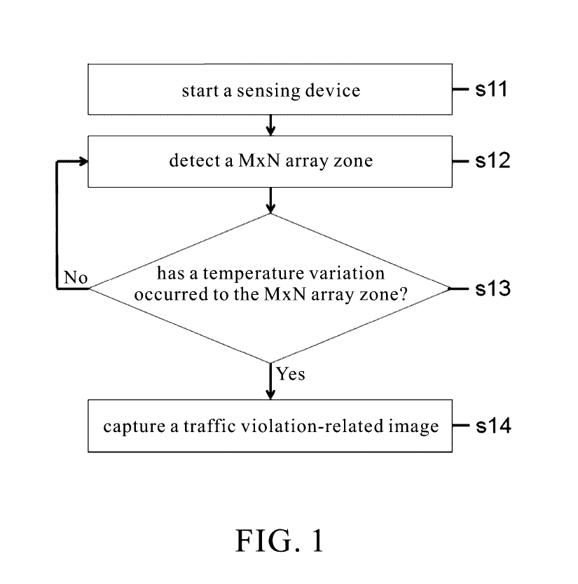

FIG. 1 is a flow chart of an infrared logical matrix-style traffic violation detection method of the present invention;

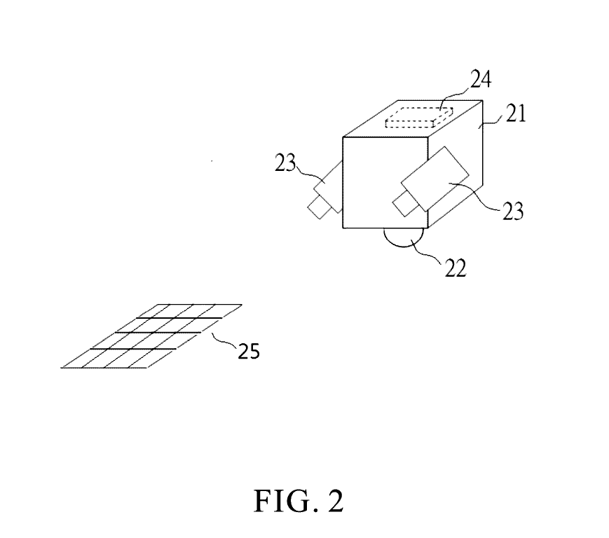

FIG. 2 is a schematic view of the framework of an infrared logical matrix-style traffic violation detection apparatus of the present invention; and

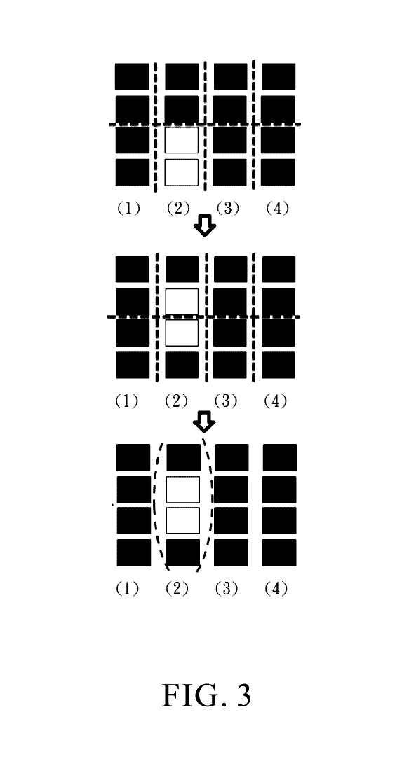

FIG. 3 is a schematic view of logical judgment made by the infrared logical matrix-style traffic violation detection apparatus of the present invention.

### DETAILED DESCRIPTION

The features and advantages of the present invention are detailed hereinafter with reference to the preferred embodiments. The detailed description is intended to enable a person skilled in the art to gain insight into the technical contents disclosed herein and implement the present invention accordingly. In particular, a person skilled in the art can easily understand the objects and advantages of the present invention by referring to the disclosure of the specification, the claims, and the accompanying drawings.

Referring to FIG. 1, the present invention provides an infrared logical matrix-style traffic violation detection method based on integration of a sensing device and an image recognizing device and adapted to detect traffic violations. The method comprises the steps described below.

Step s11: start a detection process by the sensing device, wherein a thermal energy sensing device detects an array zone temperature and generates a temperature signal.

Step s12: detect M×N array zone, wherein the thermal energy sensing device detects a temperature variation in the M×N array zone while a vehicle is passing the M×N array zone and generates a temperature variation signal.

Step s13: determine the temperature variation in the M×N array zone and receive the temperature variation signal, go to step s14 if the temperature variation is determined to be abnormal, and go back to step s12 if the temperature variation is determined to be normal. Step s13 renders it feasible to determine whether the vehicle has gone through a red light illegally, changed lane illegally, crossed a double yellow line illegally, and/or been involved in reverse driving.

Step s14: capture a traffic violation-related image.

Referring to FIG. 2, an infrared logical matrix-style traffic violation detection apparatus comprises a sensing device 22 and an image recognizing device (not shown) so as to detect traffic violations. The infrared logical matrix-style traffic violation detection apparatus comprises a body 21, the sensing device 22, a signal determination processing device 24, an image capturing device 23, and a M×N array zone 25. The body 21 is a casing which has a plurality of holes. The sensing device 22 is disposed beside the body 21 to detect what is happening to a vehicle targeted and generate a vehicle status signal. Examples of the sensing device 22 include a temperature sensor. Examples of the temperature sensor include an infrared temperature sensor, a thermal imager, a thermal imaging device and a thermal imaging camcorder. The temperature sensor operates in conjunction with a radar, a laser, and an induction coil. The signal determination processing device 24 is disposed in the body 21 to determine whether the vehicle has committed a traffic violation in accordance with a vehicle status signal generated from the sensing device 22. The signal determination processing device 24 comprises a combination of at least one of a logical circuit, a microprocessor, a DSP (digital signal processor), a FPGA program, an ASIC chip, and a computer. The image capturing device 23 is disposed beside the body 21 to drive a plurality of image capturing devices for capturing the images of the vehicle in accordance with the traffic violation vehicle signal of the signal determination processing device 24 to facilitate prosecution. The image capturing device 23 comprises a combination of at least one of a CCD, a CMOS, a camera and a camcorder. The M×N array zone 25 provides the standard against which the sensing device determines a road block temperature variation.

Referring to FIG. 3, simple logical judgment runs its course in a top-to-bottom manner. In the top; diagram of FIG. 3, a vehicle enters a sensing region (upward). In the middle diagram of FIG. 3, the vehicle triggers a rear sensing region and thus satisfies the simple logical judgment of the direction in which the vehicle is moving; meanwhile, the traffic violation detection system sends an alert and takes pictures of the vehicle for the sake of prosecution. In the absence of any sensor system for use with logical judgment, the traffic violation detection system sends the alert upon the entry of the vehicle and thus is likely to make a judgment mistake.

The present invention is characterized in that: it circumvents any visual obstacle but senses the distribution of temperature at the surfaces of an object; if the object surface temperature exceeds the absolute zero, the object generates electromagnetic wave; and, in this regard, the strength and the wavelength of the electromagnetic wave thus generated from the object vary with the surface temperature of the object. Conventional infrared sensors fall generally into two categories in accordance with the related detection principles, namely a thermal induction sensor and a photon sensor. The thermal induction sensor converts any absorbed infrared into thermal energy such that the sensor brings about a change in temperature to thereby change the physical properties of related materials, thereby detecting that a material change and thus detecting infrared. On the contrary, the photon sensor absorbs the energy derived from infrared photons such that electrons within the energy levels of the chip generates a leap to thereby effectuate the absorption of infrared and generate a voltage or current signal for the sake of measurement. Accordingly, the present invention is characterized in that a heat induction sensor functions as the primary sensing element.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. An infrared logical matrix-style traffic violation detection method, adapted to integrate a sensing device and an image recognizing device for use in detecting a traffic violation, the method comprises the steps of:
starting the sensing device, so as to detect an array zone temperature and generate a temperature signal with a thermal energy sensing device;
detecting a M×N array zone, wherein the thermal energy sensing device detects a temperature variation in the M×N array zone while a vehicle is passing the M×N array zone and generates a temperature variation signal;
determining the temperature variation in the M×N array zone and receiving the temperature variation signal, going to the step of capturing a traffic violation-related image if the temperature variation is determined to be abnormal, and going back to the step of detecting a M×N array zone if the temperature variation is determined to be normal; and
capturing a traffic violation-related image.

2. The infrared logical matrix-style traffic violation detection method of claim 1, wherein the step 3 of determining the temperature variation in the M×N array zone further comprises determining at least one of going through a red light illegally, changing lane illegally, crossing a double yellow line illegally, and reverse driving.

3. An infrared logical matrix-style traffic violation detection apparatus, adapted to integrate a sensing device and an image recognizing device for use in detecting a traffic violation, the apparatus comprising:
a body being a casing having a plurality of holes;
the sensing device disposed beside the body and adapted to detect a moving vehicle and generate a vehicle status signal;
a signal determination processing device disposed in the body and adapted to determine whether the vehicle has committed a traffic violation in accordance with a vehicle status signal generated from the sensing device;
an image capturing device disposed beside the body and adapted to drive a plurality of image capturing devices for capturing images of the vehicle in accordance with the traffic violation vehicle signal of the signal determination processing device; and
a M×N array zone for providing a standard whereby the sensing device determines a road block temperature variation.

4. The infrared logical matrix-style traffic violation detection apparatus of claim 3, wherein the sensing device is a temperature sensor.

5. The infrared logical matrix-style traffic violation detection apparatus of claim 4, wherein the temperature sensor is one of an infrared temperature sensor, a thermal imager, a thermal imaging device and a thermal imaging camcorder.

6. The infrared logical matrix-style traffic violation detection apparatus of claim 3, wherein the signal determination processing device comprises a combination of at least one of a logical circuit, a microprocessor, a DSP (digital signal processor), a FPGA program, an ASIC chip, and a computer.

7. The infrared logical matrix-style traffic violation detection apparatus of claim 3, wherein the image capturing device comprises a combination of at least one of a CCD, a CMOS, a camera and a camcorder.

8. The infrared logical matrix-style traffic violation detection apparatus of claim 4, wherein the temperature sensor operates in conjunction with at least one of a radar, a laser and an induction coil.
